(19) United States
(12) Patent Application Publication
(10) Pub. No.: US 2020/0335244 A1
(43) Pub. Date: Oct. 22, 2020

(54) CONDUCTIVE CABLE MANUFACTURING METHOD

(71) Applicant: CHIA-CHANG HSIEH, Taoyuan City (TW)

(72) Inventor: CHIA-CHANG HSIEH, Taoyuan City (TW)

(21) Appl. No.: 16/848,583

(22) Filed: Apr. 14, 2020

Related U.S. Application Data
(60) Provisional application No. 62/834,952, filed on Apr. 16, 2019.

(51) Int. Cl. H01B 13/02

(52) U.S. Cl. CPC H01B 13/02

(57) ABSTRACT

A conductive cable manufacturing method includes the following steps: providing a plurality of first strands and a plurality of second strands, wherein the total quantity of the first strands and the second strands is 2N and N is a positive integer, and the first strands are arranged to form a circle having a gravity center and the gravity center defines a central axis penetrating through the gravity center; twisting the first strands along the central axis in the same direction or interlacing the first strands with each other so as to obtain a central core body; and winding each of the second strands around the central core body clockwise or counterclockwise in order to obtain a conductive cable.

### CROSS REFERENCE TO RELATED APPLICATION

All related applications are incorporated by reference. The present application is based on, and claims priority from, U.S. Provisional Application No. 62/834,952, filed on Apr. 16, 2019, the disclosure of which is hereby incorporated by reference herein in its entirety.

### BACKGROUND OF THE INVENTION

### 1. Field of the Invention

The present invention relates to a conductive cable manufacturing method, which entwines plural strands in different spiral direction so as to manufacturing a conductive cable having enhanced tensile strength.

### 2. Description of the Prior Art

With advance of technology, various electronic products are developed in order to make human life more and more convenient. In general, when using an electronic product, the user would connect the electronic product to a power source or a load via a conductive cable, which not only can transmit electric power signals, but also can transmit data signals. Currently, there are a lot of currently available conductive cables conforming to the requirements of connecting an electronic product to a power source or a load, or transmitting different power signals or data signals. Therefore, conductive cables have been comprehensively applied to the electrical connection of various electronic devices.

Taking audio cables as an example, the audio cables of a speaker wound vibrate at the moment that the speaker makes sounds, which may make the audio cables contact with each other and then result in short-circuit of the audio signals. If the tensile strength of the audio cables is insufficient, the audio cables may be broken due to vibration. Then, the electronic device may immediately shut down and cannot work normally, or a fire disaster may be caused because of short-circuit of the cables. Therefore, it has become an important issue to provide a solution for the above problems.

### SUMMARY OF THE INVENTION

To achieve the foregoing objective, the present invention provides a conductive cable manufacturing method, which includes the following steps: providing a plurality of first strands and a plurality of second strands, wherein the total quantity of the first strands and the second strands is 2N and N is a positive integer, wherein the first strands are arranged to form a circle having a gravity center and the gravity center defines a central axis penetrating through the gravity center; twisting the first strands along the central axis in the same direction or interlacing the first strands with each other so as to obtain a central core body; and winding each of the second strands around the central core body clockwise or counterclockwise in order to obtain a conductive cable.

To achieve the foregoing objective, the present invention further provides a conductive cable manufacturing method, which includes the following steps: providing a plurality of first strands and a plurality of second strands, wherein the total quantity of the first strands and the second strands is 2N and N is a positive integer, wherein the first strands are arranged to form a circle having a gravity center and the gravity center defines a central axis penetrating through the gravity center; entwining the first strands along the central axis clockwise or counterclockwise so as to obtain a central core body, wherein any two of the adjacent first strands are entwined in different directions; and winding each of the second strands around the central core body clockwise or counterclockwise in order to obtain a conductive cable, wherein any two of the adjacent second strands are wound in different directions.

In a preferred embodiment of the present invention, a space around the central core body defines a first boundary around and close to the central core body, a second boundary around and away from the central core body, a horizontal line penetrating through the central core body, and a vertical line perpendicular to and intersecting the horizontal line, wherein the second strands are distributed over the first boundary and the second boundary, and the second strands are disposed on the horizontal line and the vertical line respectively, wherein the two second strands disposed on the horizontal line or the vertical line in pairs face to each other, and the second strand disposed on the first boundary and the second strand, opposite thereto, disposed on the second boundary are wound in different directions.

In a preferred embodiment of the present invention, the quantity of the first strands is 4 and the quantity of the second strands is 8, wherein the first boundary and the second boundary are circular. Besides, each of the first strands and the second strands is a single-wire strand.

To achieve the foregoing objective, the present invention still further provides a conductive cable manufacturing method, which includes the following steps: providing a plurality of first strands and a plurality of second strands, wherein the total quantity of the first strands and the second strands is 2N and N is a positive integer, wherein the first strands are arranged to form a circle having a gravity center and the gravity center defines a central axis penetrating through the gravity center, a third boundary close to the gravity center, a fourth boundary away from the gravity center, a horizontal line penetrating through the gravity center and a vertical line perpendicular to and intersecting the horizontal line; entwining the first strands along the central axis clockwise or counterclockwise so as to obtain a central core body, wherein the first strands are distributed over the third boundary and the fourth boundary; and winding each of the second strands clockwise and counterclockwise around the central core body in order to obtain a conductive cable, wherein any two of the adjacent second strands are wound in different direction.

In a preferred embodiment of the present invention, the two first strands disposed on the horizontal line or the vertical line in pairs face to each other, and the first strand disposed on the third boundary and the first strand, opposite thereto, disposed on the fourth boundary are wound in different directions

In a preferred embodiment of the present invention, the quantity of the first strands is 8 and the quantity of the second strands is 4, wherein the third boundary and the fourth boundary are circular. Besides, each of the first strands and the second strands is a single-wire strand.

To achieve the foregoing objective, the present invention still further provides a conductive cable manufacturing method, which includes the following steps: providing a plurality of first strands and a plurality of second strands, wherein the total quantity of the first strands and the second strands is 2N and N is a positive integer, wherein the first strands are arranged to form a circle having a gravity center and the gravity center defines a central axis penetrating through the gravity center, a third boundary close to the gravity center, a fourth boundary away from the gravity center, a horizontal line penetrating through the gravity center and a vertical line perpendicular to and intersecting the horizontal line; entwining the first strands along the central axis clockwise or counterclockwise so as to obtain a central core body, wherein the first strands are distributed over the third boundary and the fourth boundary; and winding each of the second strands clockwise or counterclockwise around the central core body so as to obtain a conductive cable, wherein a space around the central core body defines a first boundary around the central core body, a second boundary around the central core body, wherein the first boundary and the second boundary are triangular, and the second strands are distributed over the first boundary and the second boundary, and opposite to each other by centering around the central core body, wherein the second strand disposed on the first boundary and the second strand, opposite thereto, disposed on the second boundary are wound in different directions.

In a preferred embodiment of the present invention, the two first strands disposed on the horizontal line or the vertical line in pairs face to each other, and the first strand disposed on the third boundary and the first strand, opposite thereto, disposed on the fourth boundary are wound in different directions.

In a preferred embodiment of the present invention, the quantity of the first strands is 8 and a quantity of the second strands is 12. Besides, each of the first strands and the second strands is a single-wire strand.

The beneficial technical effect of the present invention is: the first strands are twisted or entwined with each other first to obtain the central core body, and then the second strands are wound around the central core body clockwise or counterclockwise to obtain the conductive cable, which not only can increase the bending resistance of the conductive cable and extend the service life thereof, but also can further enhance the safety of using the conductive cable.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures. However, it should be understood that the application should not be limited to the arrangements and the instruments shown in the drawings. The drawings include:

FIG. 1 is a flow chart of a conductive cable manufacturing method in accordance with the present invention.

FIG. 2A-FIG. 2C are transverse section views/sectional views for illustrating a conductive cable manufacturing method in accordance with a first embodiment of the present invention.

FIG. 3A-FIG. 3C are transverse section views/sectional views for illustrating a conductive cable manufacturing method in accordance with a second embodiment of the present invention.

FIG. 4A-FIG. 4C are transverse section views/sectional views for illustrating a conductive cable manufacturing method in accordance with a third embodiment of the present invention.

FIG. 5 is a product picture of a currently available conductive cable.

FIG. 6 is a product picture of a conductive cable in accordance with the first embodiment of the present invention.

FIG. 7 is a product picture of a conductive cable in accordance with the second embodiment of the present invention.

### DETAILED DESCRIPTION OF THE PREFERRED EMBODIMENT

The following description is about embodiments of the present invention; however it is not intended to limit the scope of the present invention.

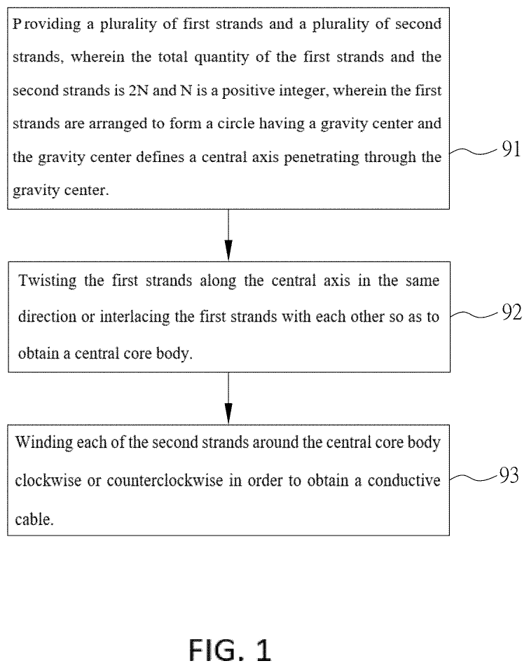

Please refer to FIG. 1, which is a flow chart of a conductive cable manufacturing method in accordance with the present invention. The method will be specifically described in the following content together with the drawings

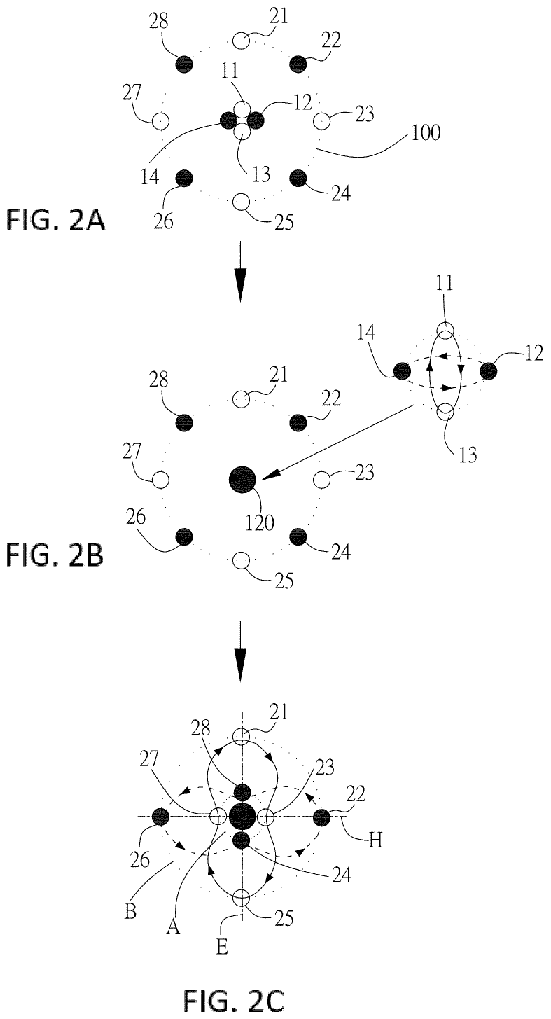

FIG. 2 shows a first preferred embodiment of the present invention. Please refer to FIG. 2A corresponding to the first step 91: providing a plurality of first strands 11˜14 and a plurality of second strands 21˜28; the quantity of the first strands 11˜14 is 4 and the quantity of the second strands 21˜28 is 8, so the total quantity is 12. Besides, the first strands 11˜14 are arranged to form a circle 100 having a gravity center and the gravity center defines a central axis penetrating through the gravity center. Please refer to FIG. 2B corresponding to the second step 92: twisting the two first strands “11, 13” along the central axis clockwise and simultaneously entwining the other two first strands “12, 14” along the central axis counterclockwise. In this way, the first strands 11˜14 can be entwined with each other to obtain a central core body 120, and the any two of the adjacent first strands are entwined in different direction. Please refer to FIG. 2C corresponding to the third step 93: winding the four second strands “21, 23, 25, 27” around the central core body 120 clockwise, and winding the other four second strands “22, 24, 26, 28” around the central core body 120 counterclockwise to obtain a conductive cable; any two of the adjacent second strands are entwined in different direction.

Afterward, the space around the central core body 120 defines a first boundary A around and close to the central core body 120, a second boundary B around and away from the central core body 120, a horizontal line H penetrating through the central core body 120, and a vertical line E perpendicular to and intersecting the horizontal line H. Besides, the first boundary A and the second boundary B are circular. More specifically, the four second strands “23, 24, 27, 28” are distributed over the first boundary A and the other four second strands “21, 22, 25, 26” are distributed over the second boundary B. Moreover, the four second strands “21, 24, 25, 28” are disposed on the vertical line E in pairs and face to each other. In addition, the second strands “24, 28” distributed over the first boundary A are wound counterclockwise and the second strands “21, 25” distributed over the second boundary B are wound clockwise. Further, the other four second strands “22, 23, 26, 27” are disposed on the horizontal line H in pairs and face to each other. In addition, the second strands “23, 27” distributed over the first boundary A are wound clockwise and the second strands “22, 26” distributed over the second boundary B are wound counterclockwise.

Furthermore, all of the first strands 11˜14 and the second strands 21˜28 are single-wire strands; the first strands 11˜14 and the second strands 21˜28 may be, but not limited to, one of copper wires, lapping wires and cotton wires, etc.

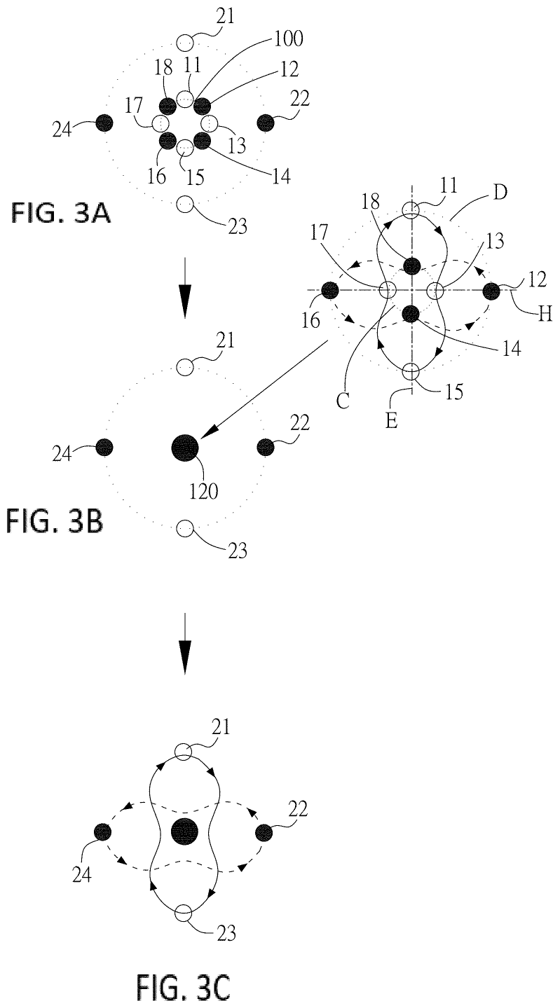

FIG. 3 shows a second preferred embodiment of the present invention; the present invention further provides another conductive cable manufacturing method including the following steps. Please refer to FIG. 3A corresponding to the first step 91: providing a plurality of first strands 11˜18 and a plurality of second strands 21˜24; the quantity of the first strands 11˜18 is 8 and the quantity of the second strands 21˜24 is 4, so the total quantity is 12. The first strands 11˜18 are arranged to form a circle 100 having a gravity center. The gravity center defines a central axis penetrating through the gravity center, a third boundary C close to the gravity center, a fourth boundary D away from the gravity center, a horizontal line H penetrating through the gravity center and a vertical line E perpendicular to and intersecting the horizontal line E. The third boundary C and the fourth boundary D are circular. Please refer to FIG. 3B corresponding to the second step 92: twisting the four first strands “11, 13, 15, 17” along the central axis clockwise and simultaneously entwining the other four first strands “12, 14, 16, 18” along the central axis counterclockwise. In this way, the first strands 11˜18 can be entwined with each other to obtain a central core body 120. In addition, the four first strands “13, 14, 17, 18” are distributed over the third boundary C and the other four first strands “11, 12, 15, 16” are distributed over the fourth boundary D. Please refer to FIG. 3C corresponding to the third step 93: winding the two second strands “21, 23” around the central core body 120 clockwise, and winding the other two second strands “22, 24” around the central core body 120 counterclockwise to obtain a conductive cable; any two of the adjacent second strands are entwined in different direction.

In addition, the other four first strands “11, 14, 15, 18” are disposed on the vertical line E in pairs and face to each other; the first strands “14, 18” distributed over the third boundary C are wound counterclockwise and the first strands “11, 15” distributed over the fourth boundary D are wound clockwise. The other four first strands “12, 13, 16, 17” are disposed on the horizontal line H in pairs and face to each other; the first strands “13, 17” distributed over the third boundary C are wound clockwise and the first strands “12, 16” distributed over the fourth boundary D are wound counterclockwise.

Furthermore, all of the first strands 11˜18 and the second strands 21˜24 are single-wire strands; the first strands 11˜18 and the second strands 21˜24 may be, but not limited to, one of copper wires, lapping wires and cotton wires, etc.

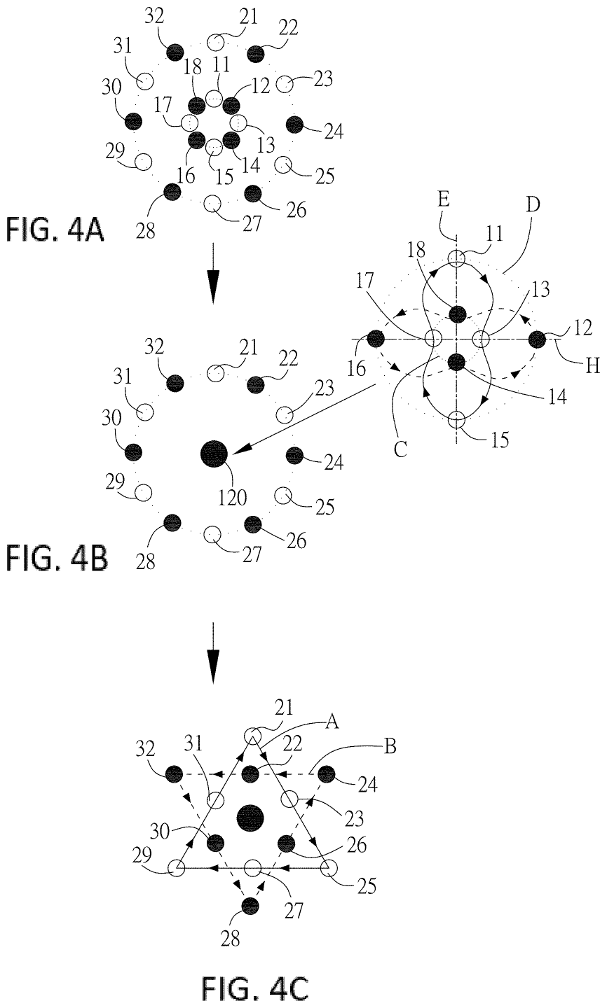

FIG. 4 shows a third preferred embodiment of the present invention. As the third preferred embodiment is similar to the second preferred embodiment, so the details similar to the second preferred embodiment will not be described again. The differences between the third preferred embodiment is the second preferred embodiment are described in the following content. The present invention further provides still another conductive cable manufacturing method including the following steps. Please refer to FIG. 4A corresponding to the first step 91: providing a plurality of first strands 11˜18 and a plurality of second strands 21˜32; the quantity of the first strands 11˜18 is 8 and the quantity of the second strands 21˜32 is 12, so the total quantity is 20. The space around the central core body 120 defines a first boundary A around the central core body 120, a second boundary B around the central core body 120, wherein the first boundary A and the second boundary B are triangular. Please refer to FIG. 4B corresponding to the second step 92: twisting the four first strands “11, 13, 15, 17” along the central axis clockwise and simultaneously entwining the other four first strands “12, 14, 16, 18” along the central axis counterclockwise. In this way, the first strands 11˜18 can be entwined with each other to obtain a central core body 120. In addition, the four first strands “13, 14, 17, 18” are distributed over the third boundary C and the other four first strands “11, 12, 15, 16” are distributed over the fourth boundary D. Please refer to FIG. 4C corresponding to the first step 93: winding the six second strands “21, 23, 25, 27, 29, 31” around the central core body 120 clockwise and winding the other six second strands “22, 24, 26, 28, 30, 32” around the central core body 120 counterclockwise to obtain a conductive cable. The six second strands “21, 23, 25, 27, 29, 31” are distributed over the first boundary A and the other six second strands “22, 24, 26, 28, 30, 32” are distributed over the second boundary B.

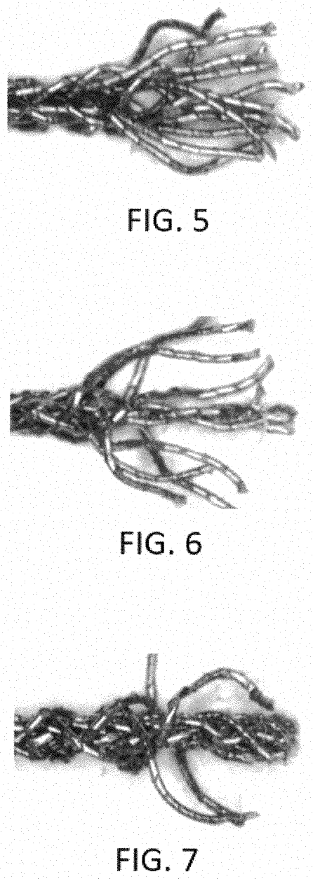

Please refer to Table 1 given below, which shows the comparison data of testing a currently available conductive cable and the conductive cables of the first and second preferred embodiments (hereinafter “Embodiment 1 and Embodiment 2”). The currently available conductive cable is manufactured by interlacing several single-wire strands. FIG. 5˜FIG. 7 are the product pictures of Embodiment 1 and Embodiment 2.

As shown in the column of bending times, the bending resistance of the currently available conductive cable is only 32,300 times; the bending resistance of the conductive cable of Embodiment 1 is up to 121,600 times and the bending resistance of the conductive cable of Embodiment 2 is also up to 135, 100 times. Therefore, the bending resistance of the conductive cables according to the present invention is 3˜4 times of that of the currently available conductive cable. In other words, the conductive cables according to the present invention have higher impact resistance and longer service life. The method for testing bending resistance is as follows: (A) the device used in the test: flexion test instrument; (B) test conditions: (1)bending angle: 180°˜270°; (2) bending frequency: 180 times/minute; (3) bending radian: R2.0; (4)heavy load: 500 g.

Besides, the softness of the conductive cable of Embodiment 1 is close to that of the currently available conductive cable, but the softness of the conductive cable of Embodiment 2 is greater than that of the currently available conductive cable so as to satisfy the requirements of different customers.

TABLE 1

| | Bare wire | | | |
|---|---|---|---|---|
| | Core | Conductive | Foil winding | Outer diameter |
| | material | foil | number | (mm) |
| Currently | Aramid | Copper-Tin alloy | 1 | 0.08 |
| available cable | | | | |
| Cable of | Aramid | Copper-Tin alloy | 1 | 0.08 |
| Embodiment 1 | | | | |
| Cable of | Aramid | Copper-Tin alloy | 1 | 0.08 |
| Embodiment 2 | | | | |

| | Gold wire | | | | | |
|---|---|---|---|---|---|---|
| | | Middle | Conductor | | Tensile | Bending |
| | Strand | diameter | resistance | Weight | strength | times |
| | quantity | (mm) | (Ω/m) | (g/m) | (N) | (load: 500 g) |
| Currently | 12 | 1.06 | 0.94 | 1.4 | 198 | 32,300 |
| available cable | | | | | | |
| Cable of | 12 | 1.09 | 0.95 | 1.44 | 184 | 121,600 |
| Embodiment 1 | | | | | | |
| Cable of | 12 | 1.11 | 0.96 | 1.43 | 141 | 135,100 |
| Embodiment 2 | | | | | | |

To sum up, the conductive cable manufacturing method according to the present invention is to twist a plurality of first strands in the same spiral direction or in different spiral directions to form a central core body, and then wind a plurality of second strands around the central core body in different spiral directions to wrap the central core body in order to obtain a conductive cable. According to the comparison result of Table 1, the bending resistance of the conductive cables manufactured by the method of the present invention is 3˜4 times of that of the currently available conductive cable. That is to say, the conductive cables according to the present invention have higher impact resistance and longer service life. Thus, the present invention can definitely achieve great technical effects.

Although the present invention has been illustrated by some preferred embodiments and the background contents of some examples, those skilled in the art would understand that the scope of the present invention exceeds the disclosed embodiments and further includes the other substitute embodiments and/or modifications and equivalents of the present invention. In addition, although many modifications of the present invention have been specifically illustrated and described, those skilled in the art would easily understand the other modifications within the scope of the present invention by referring to the specification of the present invention. It is possible to realize various combinations or sub-combinations of the specific characteristics and examples of the embodiments, and the combinations and sub-combinations are still included in the scope of the present invention. Thus, it should be understood that the characteristics and examples of the disclosed embodiments can be combined with each other or replaced by each other in order to achieve the modifications of the present invention. Hence, the scope of the present invention disclosed in the specification should not be limited by the disclosed embodiments set forth above.

Similarly, the method according to the present invention should not be interpreted corresponding to any limitations recited any one of the claims, but more than the intention of any one of the limitations recited in the claims. In addition, the present invention would be implemented by a combination without any characteristics in the disclosed embodiments. Thus, the claims following the “DETAILED DESCRIPTION OF THE PREFERRED EMBODIMENT” should be incorporated into the “DETAILED DESCRIPTION OF THE PREFERRED EMBODIMENT” and each of the claims would serve as an independent embodiment.

What is claimed is:

1. A conductive cable manufacturing method, comprising:
providing a plurality of first strands and a plurality of second strands, wherein a total quantity of the first strands and the second strands is 2N and N is a positive integer, wherein the first strands are arranged to form a circle having a gravity center and the gravity center defines a central axis penetrating through the gravity center;
twisting the first strands along the central axis in the same direction or interlacing the first strands with each other so as to obtain a central core body; and
winding each of the second strands around the central core body clockwise or counterclockwise in order to obtain a conductive cable.

2. The conductive cable manufacturing method of claim 1, wherein each of the first strands and the second strands is a single-wire strand.

3. The conductive cable manufacturing method, comprising:
providing a plurality of first strands and a plurality of second strands, wherein a total quantity of the first strands and the second strands is 2N and N is a positive integer, wherein the first strands are arranged to form a circle having a gravity center and the gravity center defines a central axis penetrating through the gravity center;
entwining the first strands along the central axis clockwise or counterclockwise so as to obtain a central core body, wherein any two of the adjacent first strands are entwined in different directions; and
winding each of the second strands around the central core body clockwise or counterclockwise in order to obtain a conductive cable, wherein any two of the adjacent second strands are wound in different directions.

4. The conductive cable manufacturing method of claim 3, wherein a space around the central core body defines a first boundary around and close to the central core body, a second boundary around and away from the central core body, a horizontal line penetrating through the central core body, and a vertical line perpendicular to and intersecting the horizontal line, wherein the second strands are distributed over the first boundary and the second boundary, and the second strands are disposed on the horizontal line and the vertical line respectively, wherein the two second strands disposed on the horizontal line or the vertical line in pairs face to each other, and the second strand disposed on the first boundary and the second strand, opposite thereto, disposed on the second boundary are wound in different directions.

5. The conductive cable manufacturing method of claim 4, wherein a quantity of the first strands is 4 and a quantity of the second strands is 8, wherein the first boundary and the second boundary are circular.

6. The conductive cable manufacturing method of claim 3, wherein each of the first strands and the second strands is a single-wire strand.

7. A conductive cable manufacturing method, comprising:
providing a plurality of first strands and a plurality of second strands, wherein a total quantity of the first strands and the second strands is 2N and N is a positive integer, wherein the first strands are arranged to form a circle having a gravity center and the gravity center defines a central axis penetrating through the gravity center, a third boundary close to the gravity center, a fourth boundary away from the gravity center, a horizontal line penetrating through the gravity center and a vertical line perpendicular to and intersecting the horizontal line;
entwining the first strands along the central axis clockwise or counterclockwise so as to obtain a central core body, wherein the first strands are distributed over the third boundary and the fourth boundary; and
winding each of the second strands clockwise and counterclockwise around the central core body in order to obtain a conductive cable, wherein any two of the adjacent second strands are wound in different direction.

8. The conductive cable manufacturing method of claim 7, wherein the two first strands disposed on the horizontal line or the vertical line in pairs face to each other, and the first strand disposed on the third boundary and the first strand, opposite thereto, disposed on the fourth boundary are wound in different directions.

9. The conductive cable manufacturing method of claim 8, wherein a quantity of the first strands is 8 and a quantity of the second strands is 4, wherein the third boundary and the fourth boundary are circular.

10. The conductive cable manufacturing method of claim 7, wherein each of the first strands and the second strands is a single-wire strand.

11. A conductive cable manufacturing method, comprising:
providing a plurality of first strands and a plurality of second strands, wherein a total quantity of the first strands and the second strands is 2N and N is a positive integer, wherein the first strands are arranged to form a circle having a gravity center and the gravity center defines a central axis penetrating through the gravity center, a third boundary close to the gravity center, a fourth boundary away from the gravity center, a horizontal line penetrating through the gravity center and a vertical line perpendicular to and intersecting the horizontal line;
entwining the first strands along the central axis clockwise or counterclockwise so as to obtain a central core body, wherein the first strands are distributed over the third boundary and the fourth boundary; and
winding each of the second strands clockwise or counterclockwise around the central core body so as to obtain a conductive cable, wherein a space around the central core body defines a first boundary around the central core body, a second boundary around the central core body, wherein the first boundary and the second boundary are triangular, and the second strands are distributed over the first boundary and the second boundary, and opposite to each other by centering around the central core body, wherein the second strand disposed on the first boundary and the second strand, opposite thereto, disposed on the second boundary are wound in different directions.

12. The conductive cable manufacturing method of claim 11, wherein the two first strands disposed on the horizontal line or the vertical line in pairs face to each other, and the first strand disposed on the third boundary and the first strand, opposite thereto, disposed on the fourth boundary are wound in different directions.

13. The conductive cable manufacturing method of claim 12, wherein a quantity of the first strands is 8 and a quantity of the second strands is 12.

14. The conductive cable manufacturing method of claim 11, wherein each of the first strands and the second strands is a single-wire strand.
